(19) United States
(12) Patent Application Publication
(10) Pub. No.: US 2008/0096751 A1
(43) Pub. Date: Apr. 24, 2008

(54) METHOD OF MANUFACTURING CERAMIC POROUS MEMBRANE AND METHOD OF MANUFACTURING CERAMIC FILTER

(75) Inventors: Manabu Isomura, Tsushima-city (JP); Tatsuya Hishiki, Nagoya-city (JP); Ichiro Wada, Kariya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/850,696

(22) Filed: Sep. 6, 2007

(30) Foreign Application Priority Data
Oct. 18, 2006 (JP) 2006-284400

(51) Int. Cl. C04B 35/624

(52) U.S. Cl. 501/39

(57) ABSTRACT

There are disclosed a method of manufacturing a thin and uniform ceramic porous membrane formed with less membrane formation times and having less defects, and a method of manufacturing a ceramic filter including the ceramic porous membrane. A UF membrane having an average pore diameter smaller than that of a porous base member is formed on the porous base member, a ceramic sol is deposited on the UF membrane, and the ceramic sol is dried with blown air and then fired to form a ceramic porous membrane having an average pore diameter smaller than that of the UF membrane.

### BACKGROUND OF THE INVENTION AND RELATED ART

The present invention relates to a method of manufacturing a ceramic porous membrane and a method of manufacturing a ceramic filter. More particularly, it relates to a method of manufacturing a thin and uniform ceramic porous membrane having less defects, and a method of manufacturing a ceramic filter including the ceramic porous membrane.

Heretofore, various methods of forming a ceramic porous membrane on a porous base member have been known. For example, a hot coating process is known (see Non-Patent Document 1). This is a method of rubbing a tube base member with cloth containing a ceramic sol to apply the sol and thereby form a porous membrane on an outer surface of the heated tube base member.

A method of forming a porous membrane on an inner surface of a porous base member having a tubular shape or a cylindrical lotus-root-like monolith shape by filtering membrane formation is also known (see Patent Documents 1 and 2). The outer surface of the porous base member is held at a pressure lower than that of an inner surface thereof which comes in contact with a sol liquid to form the membrane on the inner surface of the porous base member.

[Patent Document 1] Japanese Patent Application Laid-Open No. 3-267129

[Patent Document 2] Japanese Patent Application Laid-Open No. 61-238315

[Non-Patent Document 1] Journal of Membrane Science 149 (1988) 127 to 135

However, the hot coating process has a problem that the membrane cannot uniformly be formed on the whole surface of the base member, and the membrane can be formed on the only outer surface of the tube base member. The process cannot be applied to any monolith-type base. On the other hand, in the filtering membrane formation process, during drying of the formed membrane, a solvent present in base pores sometimes flows out on a membrane side to cause membrane peeling. As a result, there is a problem that a defect is generated in the porous membrane formed on the fired base surface. A dip coating process can be applied to the monolith type base, but the number of membrane formation times is large.

An object of the present invention is to provide a method of manufacturing a thin and uniform ceramic porous membrane formed with less membrane formation times and having less defects, and a method of manufacturing a ceramic filter including the ceramic porous membrane. Especially, an object of the present invention is to provide a method of manufacturing a ceramic porous membrane having pore diameters of 1 nm or less, and a method of manufacturing a ceramic filter suitable for dehydration from alcohol, acetic acid or the like.

### SUMMARY OF THE INVENTION

The present inventors have found that the above-mentioned objects can be achieved by depositing a ceramic sol on a base member, drying the ceramic sol with blown air and then firing the base member having the ceramic sol to form the ceramic porous membrane on the base member. That is, according to the present invention, the following method of manufacturing the ceramic porous membrane and the following method of manufacturing the ceramic filter are provided.

[1] A method of manufacturing a ceramic porous membrane, comprising: depositing a ceramic sol on the surface of a base member; drying the ceramic sol; and then firing the base member having the ceramic sol to form the ceramic porous membrane on the base member, wherein air is blown along the surface of the base member having the deposited ceramic sol thereon while the air is brought into contact with the surface of the base member, to dry the ceramic sol.

[2] A method of manufacturing a ceramic porous membrane, comprising: depositing a ceramic sol on the surface of a base member; drying the ceramic sol; and then firing the base member having the ceramic sol to form the ceramic porous membrane on the base member, wherein the ceramic sol is applied to the surface of the base member, allowed to drop down owing to a weight of the ceramic sol itself, and discharged from the surface of the base member, and the ceramic sol which is not discharged is deposited on the surface of the base member.

[3] The method of manufacturing the ceramic porous membrane according to the above [2], wherein air is blown along the surface of the base member having the deposited ceramic sol thereon while the air is brought into contact with the surface of the base member, to dry the ceramic sol.

[4] The method of manufacturing the ceramic porous membrane according to any one of the above [1] to [3], wherein a solvent of the ceramic sol includes 50 wt % or more of ethanol.

[5] The method of manufacturing the ceramic porous membrane according to any one of the above [1] to [4], wherein an average pore diameter of an outermost surface layer of the base member is in a range of 0.5 to 20 nm.

[6] The method of manufacturing the ceramic porous membrane according to any one of the above [1] to [5], wherein a component of the ceramic sol is silica.

[7] A method of manufacturing a ceramic filter, comprising: depositing a ceramic sol on the surface of a base member; drying the ceramic sol; and then firing the base member having the ceramic sol to form the ceramic porous membrane on the base member, wherein air is blown along the surface of the base member having the deposited ceramic sol thereon while the air is brought into contact with the surface of the base member, to dry the ceramic sol.

[8] A method of manufacturing a ceramic filter, comprising: depositing a ceramic sol on the surface of a base member; drying the ceramic sol; and then firing the base member having the ceramic sol to form a ceramic porous membrane on the base member, wherein the ceramic sol is applied to the surface of the base member, allowed to drop down owing to a weight of the ceramic sol itself, and discharged from the surface of the base member, and the ceramic sol which is not discharged is deposited on the surface of the base member.

[9] The method of manufacturing the ceramic filter according to the above [8], wherein air is blown along the surface of the base member having the deposited ceramic sol thereon while the air is brought into contact with the surface of the base member, to dry the ceramic sol.

[10] The method of manufacturing the ceramic filter according to any one of the above [7] to [9], wherein a solvent of the ceramic sol includes 50 wt % or more of ethanol.

[11] The method of manufacturing the ceramic filter according to any one of the above [7] to [10], wherein an average pore diameter of an outermost surface layer of the base member is in a range of 0.5 to 20 nm.

[12] The method of manufacturing the ceramic filter according to any one of the above [7] to [11], wherein a component of the ceramic sol is silica.

According to the method of manufacturing the ceramic porous membrane and the method of manufacturing the ceramic filter of the present invention, the ceramic sol is deposited on the surface of the base member, and the ceramic sol is dried with the blown air and then fired, so that the ceramic porous membrane can densely be formed. When the sol is dried with the blown air in this manner, the ceramic porous membrane is densely formed, so that the ceramic porous membrane having a small average pore diameter and a high separation performance and the ceramic filter can be manufactured. To deposit the ceramic sol on the surface of the base member, the ceramic sol is applied to the surface of the base member, allowed to drop down owing to the weight of the ceramic sol itself, and discharged from the surface of the base member, and the ceramic sol which is not discharged is deposited on the surface of the base member. In consequence, even if the base member lengthens, a difference of an amount of the deposited ceramic sol is not easily created vertically, and a membrane which is homogeneous in a length direction can be obtained. The manufacturing method of the present invention is suitable especially for manufacturing the ceramic porous membrane having pore diameters of 1 nm or less, and manufacturing the ceramic filter for use in dehydration from alcohol, acetic acid or the like.

### BRIEF DESCRIPTION OF THE DRAWINGS

FIG. 1 is a sectional view of a ceramic filter according to one embodiment of the present invention;

FIG. 2 is a perspective view of the ceramic filter according to one embodiment of the present invention;

FIGS. 3(a)(b) are schematic diagrams schematically showing one example of a method of manufacturing a silica membrane of the ceramic filter according to the present invention; and

FIGS. 4(a) to 4(e) are explanatory views of the silica membrane in a case where any UF membrane is not formed.

### DESCRIPTION OF THE REFERENCE NUMERALS

1: silica membrane, 10: ceramic filter, 11: porous base member, 14: UF membrane, 22: partition wall, 23: cell, 25: inlet-side end surface, 40: coating liquid (silica sol liquid), 41: masking tape.

### DESCRIPTION OF THE PREFERRED EMBODIMENTS

An embodiment of the present invention will hereinafter be described with reference to the drawings. The present invention is not limited to the following embodiment, and can be changed, modified or improved without departing from the scope of the present invention.

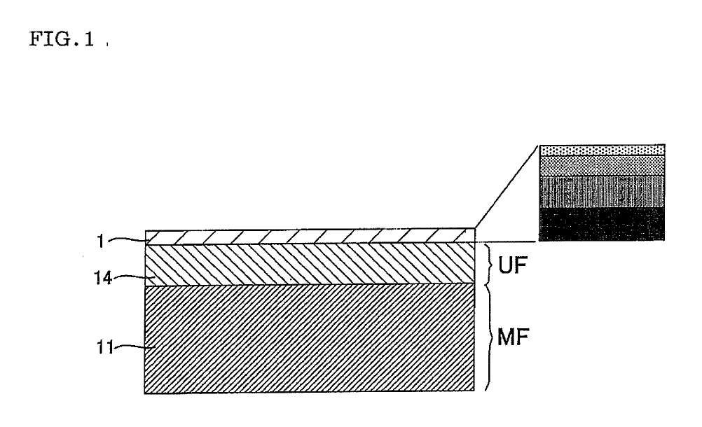

FIG. 1 shows a ceramic porous membrane 1 which is formed by a manufacturing method of the present invention. A UF membrane 14 which is an ultrafiltration membrane having pore diameters of 0.5 to 20 nm is formed on a microfiltration membrane (the MF membrane) 11, and the ceramic porous membrane 1 is formed on the UF membrane 14. As the UF membrane 14, for example, titania may be employed. It is assumed that the ceramic porous membrane 1 has a multilayered structure in which a ceramic sol is laminated a plurality of times.

In a case where the ceramic porous membrane 1 is formed on the UF membrane 14 as described above, since a membrane surface of the UF membrane 14 is smooth and has less defects, the ceramic porous membrane 1 can be formed to be thin without any defect. That is, the ceramic porous membrane 1 having a high separability and a high flux can be prepared with reduced costs.

On the other hand, when the ceramic porous membrane 1 is formed on a microfiltration membrane (the MF membrane) without forming the UF membrane 14, owing to the unevenness of the surface of the MF membrane, a ceramic layer constitutes a thick membrane in order to cover the whole surface with the ceramic porous membrane 1, thereby resulting in a low flux. Owing to the unevenness of the surface of the MF membrane, the ceramic porous membrane 1 becomes non-uniform, and defects such as cracks are easily generated. That is, a low separation performance results. Furthermore, to prevent the generation of the cracks, an only thin membrane can be formed once. The number of steps increases, and hence the costs increase. Therefore, it is preferable that the UF membrane 14 is formed, the surface of the UF membrane 14 is regarded as the surface of a base member and the ceramic porous membrane 1 is formed on the surface of the base member.

In a case where the UF membrane 14 is used as the base member for the formation of the ceramic porous membrane 1 and the ceramic porous membrane 1 is formed on the UF membrane 14, the ceramic porous membrane 1 having less defects, that is, the ceramic porous membrane 1 having a high separability can be formed. An outermost surface layer of the base member is an underlayer on which the membrane is to be formed, and is the UF membrane 14. According to a method of allowing a slurry to drip from the upside of the base member while the slurry is brought into contact with the base member and deposited on the base member as described later, since any hydraulic pressure is not applied to a membrane forming surface of the base member, the ceramic sol infiltrates the UF membrane 14 owing to a capillary force, but permeation in the base member (the porous base member 11 or the like) having large pores is inhibited. Even in a case where the base member lengthens, a difference of the amount of the deposited ceramic sol is not easily created vertically, and a membrane which is homogeneous in a length direction can be obtained. Furthermore, when air is blown to dry the base member, the ceramic porous membrane 1 can densely be formed.

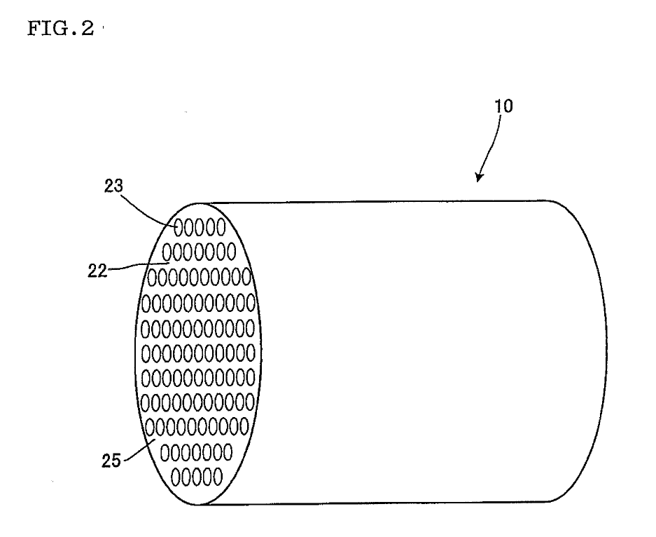

Next, one embodiment of a ceramic filter 10 in which the ceramic porous membrane 1 is formed according to a manufacturing method of the present invention will be described with reference to FIG. 2. The ceramic filter 10 of the present invention has a monolith shape including a plurality of cells 23 defined by partition walls 22 to form channel passages in an axial direction. In the present embodiment, the cells 23 have a circular section, and the ceramic porous membrane 1 shown in FIG. 1 is formed on inner wall surfaces of the cells. The cells 23 may be formed so as to have a hexagonal or quadrangular section. According to such a structure, for example, when a mixture (e.g., water and acetic acid) is introduced into the cells 23 from an inlet-side end surface 25, one of constituting elements of the mixture is separated at the silica membrane 1 formed on the inner walls of the cells 23, transmitted through the porous partition walls 22 and discharged from an outermost wall of the ceramic filter 10, so that the mixture can be separated. That is, the ceramic porous membrane 1 formed in the ceramic filter 10 can be used as a separation membrane, and has a high separation characteristic with respect to, for example, water and alcohol or water and acetic acid.

The porous base member 11 as a base member main body is formed as a columnar monolith-type filter element formed of a porous material by extrusion or the like. As the porous material, for example, alumina may be used, because this material has a resistance to corrosion, pore diameters of a filtering portion scarcely change even with a temperature change and a sufficient strength can be obtained. However, instead of alumina, a ceramic material such as cordierite, mullite or silicon carbide may be used. The porous base member 11 is a porous body in which a surface (an outermost surface layer) to be provided with the ceramic porous membrane 1 has pore diameters of preferably 0.5 to 20 nm, more preferably 0.5 to 10 nm and which has a large number of pores having small pore diameters. On the surface of this porous body, a porous membrane having the pore diameters in the above range (the UF membrane 14 forms the outermost surface layer in the above range in the embodiment of FIG. 1) may be formed.

Since the ceramic porous membrane 1 of the present invention is formed on an inner peripheral surface (an inner wall surface) of the porous base member 11, a comparatively long cylindrical base having a length of 50 cm or more, or a porous base member having a lotus-root-like shape may preferably be used.

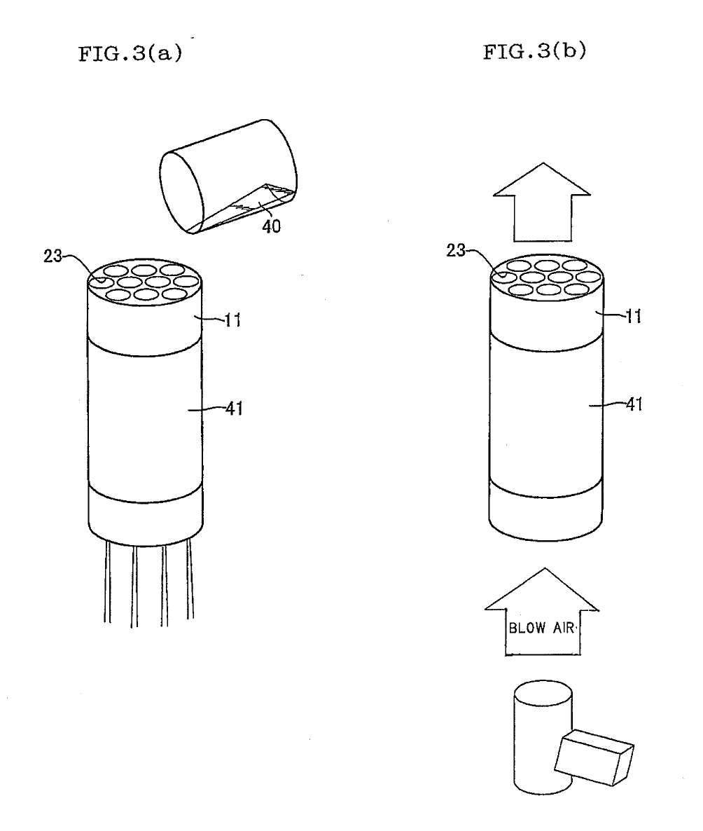

Next, a method of manufacturing the ceramic porous membrane 1 will be described with reference to FIGS. 3(a) and 3(b). First, a coating liquid (a silica sol liquid) 40 for forming the ceramic porous membrane 1 is prepared. To prepare the coating liquid 40, tetraethoxy silane is hydrolyzed in the presence of nitric acid at 50° C. for five hours to form a sol liquid, and the sol liquid is diluted with ethanol and regulated so as to obtain a concentration of 0.1 to 2.0 wt % in terms of silica. If the silica concentration is as high as 2.5 wt % or more, the membrane thickens and the cracks are easily generated, but the number of coating times to be repeated until the membrane developing a separability is completed is reduced. On the other hand, if the silica concentration is low, the membrane becomes thin, and the cracks are not easily generated, but the number of the coating times tends to increase. At the first coating, since a large amount of the coating liquid infiltrates the base member, the silica concentration is reduced. At the second coating, the silica concentration may be increased (e.g., when the silica concentration of the coating liquid at the first coating is set to 0.35 wt % and the concentration of the coating liquid after the second coating is set to 0.7 wt %, the membrane having less defects can be obtained).

It is assumed that the coating liquid diluted with ethanol has an ethanol concentration of 50 to 99.5 wt %. The coating liquid may be diluted with water instead of ethanol, but when the liquid is diluted with ethanol, the membrane can be formed to be thin at one membrane formation time, and the membrane having a high flux can be obtained. Here, as a component of a ceramic sol, silica is used, but a sol containing a component of titania or zirconia instead of silica may be used.

Next, as shown in FIG. 3(a), an outer peripheral surface of the porous base member 11 is masked with a masking tape 41. The porous base member 11 is fixed to, for example, a lower end of a wide-mouthed funnel (not shown), and the coating liquid (the silica sol liquid) 40 is passed through the cells 23 from an upper portion of the base member. In other words, a silica sol is deposited on the surfaces of the cells 23. The porous base member 11 is shaken by hands several times to fly and remove a surplus sol.

Subsequently, as shown in, for example, FIG. 3(b), air is blown into the cells with a drier or the like to dry the cells. A temperature of the air is preferably 10 to 80° C. If the air at a temperature lower than 10° C. is passed, the drying of the silica sol deposited on the surfaces of the cells does not progress. Therefore, a dense membrane is not obtained, and the membrane has large pore diameters. If hot air at a temperature higher than 80° C. is passed, the cracks are unfavorably easily generated in the membrane surface. A speed at which the air for drying passes through the cells may be set to 0.1 to 100 m/second. If the speed at which the air passes through the cells is 0.1 m/second or less, a time required for drying excessively lengthens. If the speed at which the air passes through the cells is 100 m/second or more, the cracks are unfavorably easily generated in the membrane surface. When the sol is dried with the blown air in this manner, the silica membrane 1 can densely be formed on the UF membrane 14. It is considered to be important that a solvent is dried from the membrane surface. Therefore, the outer peripheral surface of the base member may be covered with a mask to prevent evaporation of the solvent containing the silica sol from a base member side.

Subsequently, a temperature is raised at a ratio of 100° C./hr, retained at 500° C. for one hour, and then lowered at a ratio of 100° C./hr. Operations such as the passing of the coating liquid (the silica sol liquid) 40, drying, temperature raising and temperature lowering are repeated three to five times.

It is to be noted that the forming of the silica membrane 1 is not limited to the passing of the silica sol liquid 40 shown in FIG. 3(a), and the membrane may be formed by a dipping process and then dried with the blown air as shown in FIG. 3(b).

According to the above steps, the UF membrane 14 is used as the base member, and the silica membrane 1 which is the ceramic porous membrane is formed on the surface of the UF membrane 14.

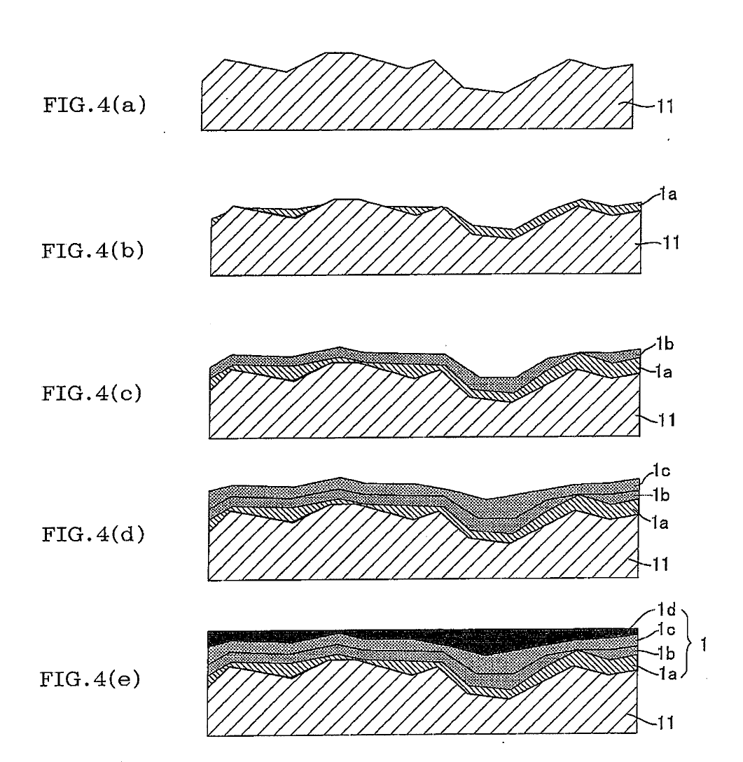

On the other hand, in a case where the silica membrane 1 is directly formed on the MF membrane 11 shown in FIG. 4(a), even when a silica membrane 1a is formed as shown in FIG. 4(b), the whole surface cannot be covered, and the cracks are easily generated in the silica membrane 1 owing to unevenness. As shown in FIGS. 4(c) to 4(e), when silica membranes 1b, 1c and 1d are superimposed to form a thick membrane, the silica membrane 1 can be flattened, but in this case, a low flux results. Since the number of the steps increases, the costs increase.

Moreover, since the silica sol is dried with the blown air, the silica membrane 1 having a dense structure is formed on the UF membrane 14, and the membrane having a high resolution can be obtained.

The ceramic filter 10 obtained as described above and including the nano-level thin-membrane-like silica membrane 1 formed on the inner wall surface thereof can preferably be used as a filter which separates a mixed liquid or the like. It is to be noted that when the cells 23 are treated with acetic acid, a separation factor can be improved. Specifically, when the ceramic filter is submerged in an acetic acid solution for a certain period, a ceramic filter having a high separation factor can be obtained as compared with a case where the filter is not submerged.

### Examples

A manufacturing method of the present invention will hereinafter be described in accordance with examples in more detail, but the present invention is not limited to these examples. First, a porous base member, a ceramic sol liquid, a membrane forming method and the like used in the present example will be described.

### Examples 1 to 5

### (1) Porous Base Member

A material provided with a UF membrane having an average pore diameter of 0.5 to 30 nm and having a monolith shape (an outer diameter of 30 mm, a cell inner diameter 3 mm×37 cells and a length of 65 to 1000 mm) was used as a base member. It is to be noted that opposite end portions of the base member were sealed with glass.

### (2) Ceramic Sol Liquid

Metal alkoxide was hydrolyzed in the presence of nitric acid at 5 to 100° C. for one to twelve hours to obtain each of a silica sol, a titania sol and a zirconia sol. The resultant sol liquid was diluted with alcohol or water to obtain a coating liquid. To manufacture the silica sol, tetraethoxy silane was hydrolyzed in the presence of nitric acid at 50° C. for five hours to obtain a sol liquid, and the sol liquid was diluted with ethanol or water, and regulated into a concentration of 0.1 to 2.0 wt % in terms of silica.

### (3) Membrane Formation

(a) Pouring of Liquid

An outer peripheral surface of a sample (a porous base member) was masked with a masking tape 41. A porous base member 11 was fixed to a mouth portion of a funnel, and 60 ml of silica sol liquid was poured and passed through cells from an upper portion of the base member via the wide-mouthed funnel. Afterward, the wide-mouthed funnel was removed, and the base member was moved so as to be shaken by hands to remove a surplus sol liquid. It is to be noted that in this membrane formation step, it was confirmed that the membrane was formed on the whole inner wall of the sample.

(b) Dipping

The outer peripheral surface of the porous base member was not masked with a tape but the porous base member was set in a membrane formation chamber. Subsequently, the silica sol liquid was supplied from a lower portion of the base member at a liquid supply speed of 1.0 L/min with a liquid supply pump. When a surplus sol liquid flowed from an upper portion of the base member, liquid supply was stopped, and a liquid discharge valve was opened to discharge the silica sol liquid from this system. Afterward, the base member was removed from the membrane formation chamber, the base member was moved so as to be shaken by hands, and the surplus sol liquid was removed.

### (4) Drying

(a) Blowing of Air

Cells 23 of the porous base member 11 into which the silica sol was poured were dried for one to two hours by use of a drier so that air at room temperature passes through the cells.

(b) Adjustment of Humidity

The drying was quantitatively performed in a chamber at a temperature of 30° C. and a relative humidity of 50% to prepare a sample.

### (5) Firing

The masking tape was removed from the outer peripheral surface of the sample, and the temperature was raised with an electric furnace at a ratio of 100° C./hr, retained at 500° C. for one hour and lowered at a ratio of 100° C./hr. It is to be noted that the above operations of (3) to (5) were repeated four times to obtain the samples of the examples.

### Example 1

A membrane formation method and a drying method of a ceramic porous membrane were changed, and the membrane formation method and the drying method were investigated. Details of a base member and a ceramic sol are described in Table 1.

### Example 2

A concentration of a dilution solvent of a ceramic sol was changed, and influences of the dilution solvent were investigated. Details of a base member, a ceramic sol material, a membrane formation method and a drying method are described in Table 1. When the concentration of the ceramic sol was less than 50%, a separation factor α was as small as less than 50.

### Example 3

Pore diameters of a porous base member were changed to investigate influences of the pore diameters. When the pore diameters of the porous base member were in excess of 20 nm, a separation factor α was reduced.

### Example 4

A length of a porous base member was changed to investigate influences of the length.

### Example 5

A concentration of a ceramic sol and the number of membrane formation times were changed to investigate influences of the concentration and the number of the membrane formation times.

### Comparative Example 1

This example showed results in a case where dipping membrane formation and drying with humidity adjustment were performed.

(Evaluation)

A water-ethanol separation test was conducted.

Specifically, an aqueous solution having a temperature of 70° C. and an ethanol concentration of 90% was circulated through cells of a silica membrane monolith (a cell inner diameter of 3 mm, 37 cells) of φ30×65 L (a diameter of 30 mm×a length of 65 mm (with the proviso that the length differed in Example 4)) at a liquid supply speed of 12 L/min. A pressure was reduced from a side surface of a base member with a vacuum degree of about 2 to 5 Pa, and a transmitted liquid from the base member side surface was trapped with a liquid nitrogen trap. A separation factor was calculated from the ethanol concentrations of the transmitted and trapped liquid and an original liquid before transmitted. The separation factor and the flux are shown in Table 1.

TABLE 1

| | | | | | | | | Membrane | | | | |
|---|---|---|---|---|---|---|---|---|---|---|---|---|
| | Porous base member | | | Ceramic sol | | | | formation | | | Performance | |
| | | Pore | | | Concen- | | Ethanol | | Number | | | Flux |
| | | diameter | | | tration | Dilution | concen- | | of | | Separation | (kg/ |
| No. | Material | (nm) | Length (mm) | Material | wt % | solvent | tration | Method | times | Drying | factor α | m²h) |
| Example 1-1 | Titania | 10 | 65 | Silica | 1 | Ethanol | 96% | Pouring | 4 | Air blowing 10 | 500 | 2.0 |
| Example 1-2 | Titania | 10 | 65 | Silica | 1 | Ethanol | 96% | Dipping | 4 | Air blowing 10 | 50 | 2.5 |
| Example 1-3 | Titania | 10 | 65 | Silica | 1 | Ethanol | 96% | Pouring | 4 | Humidity | 50 | 2.5 |
| | | | | | | | | | | adjustment | | |
| Example 1-4 | Titania | 10 | 65 | Silica | 1 | Ethanol | 96% | Pouring | 4 | Air blowing 0.05 | 50 | 2.3 |
| Example 1-5 | Titania | 10 | 65 | Silica | 1 | Ethanol | 96% | Pouring | 4 | Air blowing 0.1 | 150 | 2.5 |
| Example 1-6 | Titania | 10 | 65 | Silica | 1 | Ethanol | 96% | Pouring | 4 | Air blowing 100 | 200 | 2.4 |
| Example 1-7 | Titania | 10 | 65 | Silica | 1 | Ethanol | 96% | Pouring | 4 | Air blowing 200 | 50 | 2.3 |
| Example 1-8 | Titania | 10 | 65 | Zirconia | 1 | Ethanol | 96% | Pouring | 4 | Air blowing 10 | 40 | 2.5 |
| Example 1-9 | Titania | 10 | 65 | Titania | 1 | Ethanol | 96% | Pouring | 4 | Air blowing 10 | 40 | 2.5 |
| Example 1-10 | Silica | 10 | 65 | Silica | 1 | Ethanol | 96% | Pouring | 4 | Air blowing 10 | 50 | 2.5 |
| Example 2-1 | Titania | 10 | 65 | Silica | 1 | Water, | 90% | Pouring | 4 | Air blowing 10 | 100 | 2.3 |
| | | | | | | ethanol | | | | | | |
| Example 2-2 | Titania | 10 | 65 | Silica | 1 | Water, | 80% | Pouring | 4 | Air blowing 10 | 75 | 2.5 |
| | | | | | | ethanol | | | | | | |
| Example 2-3 | Titania | 10 | 65 | Silica | 1 | Water, | 50% | Pouring | 4 | Air blowing 10 | 50 | 2.6 |
| | | | | | | ethanol | | | | | | |
| Example 2-4 | Titania | 10 | 65 | Silica | 1 | Water, | 20% | Pouring | 4 | Air blowing 10 | 9 | 3.0 |
| | | | | | | ethanol | | | | | | |
| Example 2-5 | Titania | 10 | 65 | Silica | 1 | Water, | 5% | Pouring | 4 | Air blowing 10 | 5 | 3.4 |
| | | | | | | ethanol | | | | | | |
| Example 3-1 | Titania | 0.5 | 65 | Silica | 1 | Ethanol | 96% | Pouring | 4 | Air blowing 10 | 500 | 1.8 |
| Example 3-2 | Titania | 2 | 65 | Silica | 1 | Ethanol | 96% | Pouring | 4 | Air blowing 10 | 500 | 2.1 |
| Example 3-3 | Titania | 20 | 65 | Silica | 1 | Ethanol | 96% | Pouring | 4 | Air blowing 10 | 300 | 2.1 |
| Example 3-4 | Titania | 30 | 65 | Silica | 1 | Ethanol | 96% | Pouring | 4 | Air blowing 10 | 20 | 2.7 |
| Example 4-1 | Titania | 10 | 500 | Silica | 1 | Ethanol | 96% | Pouring | 4 | Air blowing 10 | 500 | 2.0 |
| Example 4-2 | Titania | 10 | 1000 | Silica | 1 | Ethanol | 96% | Pouring | 4 | Air blowing 10 | 500 | 2.0 |
| Example 5-1 | Titania | 10 | 65 | Silica | 0.1 | Ethanol | 99% | Pouring | 20 | Air blowing 10 | 500 | 2.0 |
| Example 5-2 | Titania | 10 | 65 | Silica | 2 | Ethanol | 89% | Pouring | 2 | Air blowing 10 | 200 | 2.5 |
| Comparative | Titania | 10 | 65 | Silica | 1 | Ethanol | 96% | Dipping | 4 | Humidity | 1 | 4.6 |
| example 1 | | | | | | | | | | adjustment | | |

Pore diameters of a porous base member of Table 1 correspond to those of a UF membrane 14 of FIG. 1. Numeric values described in a column of drying are values of an air supply amount (L/min).

As shown in Table 1, when a ceramic sol is deposited on a porous base member having surface pore diameters in a range of 0.5 to 20 nm to perform drying with blown air, a flux is not reduced, and a separation factor can be increased. That is, according to a method of manufacturing a ceramic porous membrane of the present invention, when the ceramic sol is deposited on the surface of the base member, dried with blown air and then fired, the ceramic porous membrane can densely be formed. When the drying is performed with the blown air in this manner, the ceramic porous membrane becomes dense. Therefore, the ceramic porous membrane having a small average pore diameter and a high separability can be manufactured. To deposit the ceramic sol on the surface of the base member, the ceramic sol is applied to the surface of the base member, drops down owing to a weight of the sol itself and is discharged from the surface of the base member. A ceramic sol which is not discharged is deposited on the surface of the base member. In consequence, if the base member is long, a difference of an amount of the deposited ceramic sol is not easily created vertically, and a membrane which is homogeneous in a length direction can be obtained. Furthermore, in a case where the ceramic sol in which a dilution solvent includes 50 wt % or more of ethanol is used, a satisfactory ceramic porous membrane can be formed.

According to the present invention, a thin and uniform membrane having less coarse and large pores and less defects can be obtained with less membrane formation times. Therefore, a ceramic filter provided with such a silica membrane can preferably be used as a filter. A ceramic filter including a nano-level thin-membrane-like silica membrane formed on the inner wall surface thereof can be used in a portion where an organic filter cannot be used, for example, separation removal or the like in an acidic or alkaline solution or an organic solvent.

What is claimed is:

1. A method of manufacturing a ceramic porous membrane, comprising: depositing a ceramic sol on the surface of a base member; drying the ceramic sol; and then firing the base member having the ceramic sol to form the ceramic porous membrane on the base member, wherein air is blown along the surface of the base member having the deposited ceramic sol thereon while the air is brought into contact with the surface of the base member, to dry the ceramic sol.

2. A method of manufacturing a ceramic porous membrane, comprising: depositing a ceramic sol on the surface of a base member; drying the ceramic sol; and then firing the base member having the ceramic sol to form the ceramic porous membrane on the base member, wherein the ceramic sol is applied to the surface of the base member, allowed to drop down owing to a weight of the ceramic sol itself, and discharged from the surface of the base member, and the ceramic sol which is not discharged is deposited on the surface of the base member.

3. The method of manufacturing the ceramic porous membrane according to claim 2, wherein air is blown along the surface of the base member having the deposited ceramic sol thereon while the air is brought into contact with the surface of the base member, to dry the ceramic sol.

4. The method of manufacturing the ceramic porous membrane according to claim 1, wherein a solvent of the ceramic sol includes 50 wt % or more of ethanol.

5. The method of manufacturing the ceramic porous membrane according to claim 2, wherein a solvent of the ceramic sol includes 50 wt % or more of ethanol.

6. The method of manufacturing the ceramic porous membrane according to claim 1, wherein an average pore diameter of an outermost surface layer of the base member is in a range of 0.5 to 20 nm.

7. The method of manufacturing the ceramic porous membrane according to claim 2, wherein an average pore diameter of an outermost surface layer of the base member is in a range of 0.5 to 20 nm.

8. The method of manufacturing the ceramic porous membrane according to claim 1, wherein a component of the ceramic sol is silica.

9. The method of manufacturing the ceramic porous membrane according to claim 2, wherein a component of the ceramic sol is silica.

10. A method of manufacturing a ceramic filter, comprising: depositing a ceramic sol on the surface of a base member; drying the ceramic sol; and then firing the base member having the ceramic sol to form the ceramic porous membrane on the base member, wherein air is blown along the surface of the base member having the deposited ceramic sol thereon while the air is brought into contact with the surface of the base member, to dry the ceramic sol.

11. A method of manufacturing a ceramic filter, comprising: depositing a ceramic sol on the surface of a base member; drying the ceramic sol; and then firing the base member having the ceramic sol to form a ceramic porous membrane on the base member, wherein the ceramic sol is applied to the surface of the base member, allowed to drop down owing to a weight of the ceramic sol itself, and discharged from the surface of the base member, and the ceramic sol which is not discharged is deposited on the surface of the base member.

12. The method of manufacturing the ceramic filter according to claim 11, wherein air is blown along the surface of the base member having the deposited ceramic sol thereon while the air is brought into contact with the surface of the base member, to dry the ceramic sol.

13. The method of manufacturing the ceramic filter according to claim 10, wherein a solvent of the ceramic sol includes 50 wt % or more of ethanol.

14. The method of manufacturing the ceramic filter according to claim 11, wherein a solvent of the ceramic sol includes 50 wt % or more of ethanol.

15. The method of manufacturing the ceramic filter according to claim 10, wherein an average pore diameter of an outermost surface layer of the base member is in a range of 0.5 to 20 nm.

16. The method of manufacturing the ceramic filter according to claim 11, wherein an average pore diameter of an outermost surface layer of the base member is in a range of 0.5 to 20 nm.

17. The method of manufacturing the ceramic filter according to claim 10, wherein a component of the ceramic sol is silica.

18. The method of manufacturing the ceramic filter according to claim 11, wherein a component of the ceramic sol is silica.
